(19) United States
(12) Patent Application Publication
(10) Pub. No.: US 2024/0289394 A1
(43) Pub. Date: Aug. 29, 2024

(54) WEB PAGE CLASSIFICATION METHOD, APPARATUS, STORAGE MEDIUM AND ELECTRONIC DEVICE

(71) Applicant: Lemon Inc., Grand Cayman (KY)

(72) Inventors: Han WANG, Los Angeles, CA (US); Hongyu XIONG, Los Angeles, CA (US); Yiqi FENG, Los Angeles, CA (US); Zhen LIU, Beijing (CN); Haocheng ZHANG, Los Angeles, CA (US); Bin LIU, Los Angeles, CA (US)

(21) Appl. No.: 18/572,097

(22) PCT Filed: Jun. 2, 2022
(86) PCT No.: PCT/SG2022/050381

§ 371 Date: Dec. 19, 2023

(30) Foreign Application Priority Data
Jul. 7, 2021 (CN) 202110768852.5

(51) Int. Cl. G06F 16/906; G06F 16/9535; G06F 16/958

(52) U.S. Cl. CPC G06F 16/906; G06F 16/9535; G06F 16/958

(57) ABSTRACT

The present disclosure relates to a web page classification method, apparatus, storage medium, and electronic device. The method comprises: acquiring feature information of a web page to be classified; respectively predicting, according to each piece of the feature information, a candidate web page category of the web page to be classified; and determining, from all the candidate web page categories, a target web page category to which the web page to be classified belongs. The candidate web page category of the web page to be classified is predicted by using various feature information of the web page to be classified, and the target web page category of the web page to be classified is further determined from the candidate web page categories, thereby improving the accuracy of web page classification.

### CROSS-REFERENCE TO RELATED APPLICATION(S)

The present application claims the priority of the Chinese patent application entitled “Web Page Classification Method, Apparatus, Storage Medium and Electronic Device” with the application number of 202110768852.5 and the filing date of Jul. 7, 2021, the content of which is hereby incorporated by reference in its entirety.

### FIELD

The present disclosure relates to the technical field of classification, and more specifically, to a web page classification method, apparatus, storage medium and electronic device.

### BACKGROUND

Classification is a very important and universal problem facing mankind. Classifying things correctly helps people to understand the world and to bring order to the chaotic reality of the world.

In the related technology, the classified information of web pages is widely used in search, advertisement and other Internet fields. How to accurately classify web pages remains a long-standing research and exploration problem in the computer field.

### SUMMARY

This Summary is provided to introduce concepts in a simplified form that are further described below in the Detailed Description. This Summary is not intended to identify key features or essential features of the technical solution as defined, nor is it intended to be used to limit the scope thereof.

In a first aspect, the present disclosure provides a web page classification method, comprising:
obtaining feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified; respectively predicting a candidate web page category of the web page to be classified according to each feature information; determining a target web page category to which the web page to be classified belongs from all the candidate web page categories of the web page to be classified.

In a second aspect, the present disclosure provides a web page classification apparatus, comprising:
a first obtaining module for obtaining feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified; a predicting module for respectively predicting a candidate web page category of the web page to be classified according to each feature information; a determining module for determining a target web page category to which the web page to be classified belongs from all the candidate web page categories of the web page to be classified.

In a third aspect, the present disclosure provides a computer readable medium, on which a computer program is stored, the program, when executed by processing means, performing steps of the web page classification method in the first aspect.

In a fourth aspect, the present disclosure provides an electronic device, comprising:
storage means, on which a computer program is stored;
processing means, for executing the computer program in the storage means to perform steps of the web page classification method in the first aspect.

With the above technical solution, the accuracy of web page classification can be improved by using various feature information of the web page to be classified to predict candidate web page categories of the web page to be classified and further determining the target web page category of the web page to be classified from the candidate web page categories; moreover, as the feature information used for web page classification is selected from the search engine optimization information, the web page sharing information, the web page advertisement information and the web page rendering information, and the classification is performed by using feature information related to web pages in different dimensions, the accuracy of web page classification can be radically improved.

Other features and advantages of the present disclosure will be explained in detailed in the following Detailed Description of Embodiments.

### BRIEF DESCRIPTION OF THE DRAWINGS

Through the more detailed description of detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn scale. Among the figures,

FIG. 1 a flowchart of a web page classification method according to an example embodiment of the present disclosure;

FIG. 2 is a block diagram of a web page classification apparatus according to an example embodiment of the present disclosure; and

FIG. 3 is a block diagram of an electronic device according to an example embodiment of the present disclosure.

### DETAILED DESCRIPTION OF EMBODIMENTS

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in different order and/or in parallel. Furthermore, method implementations may include additional steps and/or omit steps that are shown. The scope of the present disclosure is not limited in this regard.

The terms “comprise” and its variants used herein are to be read as open terms that mean “include, but is not limited to.” The term “based on” is to be read as “based at least in part on.” The term “one embodiment” is to be read as “at least one embodiment,” the term “another embodiment” is to be read as “at least one another embodiment,” and the term “some embodiments” is to be read as “at least some embodiments.” Other definitions, explicit and implicit, might be included below.

It should be noted that concepts “first,” “second” and the like mentioned in the present disclosure are only used to distinguish between different apparatuses, modules or units, rather than limiting the order or interdependence of the functions performed by these apparatuses, modules or units.

It should be noted that modifications “one” and “more” mentioned in the present disclosure are schematic and not limiting, and should be understood as “one or more” to those skilled in the art unless otherwise specified.

Names of messages or information exchanged between the plurality of apparatuses in implementations of the present disclosure are used for illustrative purposes only and are not intended to limit the scope of those messages or information.

As described in the Background, how to accurately classify web pages has been a long-standing research and exploration problem in the computer field. In the related technology, classifying web pages based on single web page text makes it difficult to accurately identify different categories of web pages.

To sum up, the present disclosure provides a web page classification method, which can radically improve the accuracy of web page classification by using feature information related to web pages in different dimensions.

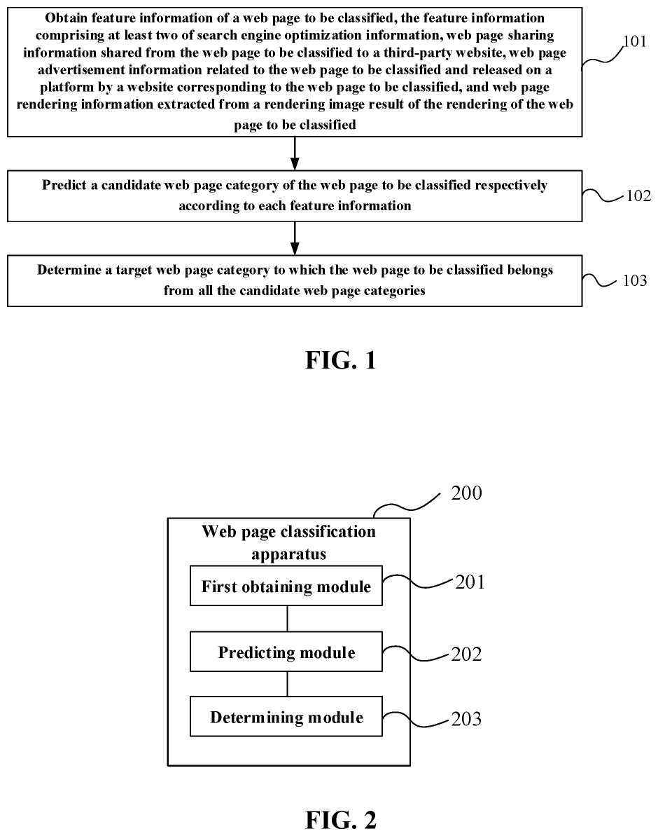

FIG. 1 is a flowchart of a web page classification method according to an example embodiment of the present disclosure.

With reference to FIG. 1, the web page classification method comprises:

Step 101, feature information of a web page to be classified is obtained. The feature information comprises at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified.

Step 102, a candidate web page category of the web page to be classified is respectively predicted according to various feature information.

Step 103, a target web page category to which the web page to be classified belongs is determined from all the candidate web page categories of the web page to be classified.

In this way, the accuracy of web page classification may be improved by using various feature information of the web page to be classified to predict a candidate web page category of the web page to be classified and further determining a target web page category of the web page to be classified from the candidate web page categories; moreover, as the feature information used for web page classification is selected from the search engine optimization information, the web page sharing information, the web page advertisement information and the web page rendering information, and the classification is performed by using feature information related to web pages in different dimensions, the accuracy of web page classification can be radically improved.

In order to help those skilled in the art to better understand the web page classification method provided by the present disclosure, the above steps will be illustrated by way of example.

First of all, it is noteworthy that the category of the page may be sports, fiction, shopping, news, etc. The present disclosure is not intended to limit in this regard.

In the present disclosure, the search engine optimization information may refer to, based on the understanding of the search engine natural ranking mechanism, the internal and external adjustments and optimization of the website to improve the natural ranking of keywords of the website in the search engine and obtain more traffic, to achieve the goal of website sales and brand building. As an example, the search engine optimization information may be information in the header elements, keyword tags and description tags in the hypertext markup language in which the web page to be classified is constructed.

In some web pages, usually a connection to a third-party website may be established to facilitate users to quickly share the web page to the third-party website, so that the real-time field sharing of web pages may be achieved without the need for users to log in to the third-party website. As an example, the web page sharing information may be a website address of the web page to be classified, a web page title of the web page to be classified, and web page content of the web page to be classified.

The web page advertisement information is an advertisement delivered to users. The web page advertisement information may be placed in platforms such as web pages, applications or other digital environments. As an example, the web page advertisement information may be information placed in a format such as video, picture, audio, etc.

The web page rendering is the process by which a browser turns the hypertext markup language of the web page into an image the user can visually observe. As an example, the web page rendering information may refer to information that is extracted from image rendering results of rendering the web page to be classified. It may be understood that the extracted information may be textual information or picture information, and the present embodiment is not intended to limit in this regard.

Alternatively, OCR (Optical Character Recognition) technology may be used to extract the web page rendering information from a salient region of the image rendering results, wherein the salient region refers to the middle center position of the web page to be classified on the display. It may be understood that information that is closely associated with the web page will be in the center position of the display interface. Therefore, the web page rendering information may be extracted in the middle center position on the display. Moreover, the center position may be determined by the resolution of the display.

Alternatively, NLP (Natural Language Processing) technology in related technology may be used to predict a candidate web page category corresponding to each kind of feature information, which is not detailed in the present embodiment.

Alternatively, the step of determining the target web page category from all the candidate web page categories in FIG. 1 may comprise: determining a confidence of each feature information; normalizing all the confidences; and where the largest confidence among all the normalized confidences is greater than or equal to a first preset threshold, determining a candidate web page category corresponding to the feature information corresponding to the largest confidence as the target web page category to which the web page to be classified belongs.

It is noteworthy that the confidence of information characterizes the credibility of this kind of information. Accordingly, the higher the credibility, the higher the accuracy of the category thereof.

In the present disclosure, the normalization processing refers to mapping different data into the range of 0 to 1 to facilitate the comparison between different data.

In the present disclosure, the first preset threshold may be set according to actual situation, which is not limited in the present embodiment.

Considering the increasing complexity of the structure of the website, the credibility of the feature information of the web page will be affected to different extent. For example, many website developers resort to cheating by adjusting a web page and adding content unrelated to the page to improve the ranking in search. Therefore, by calculating a confidence for each kind of feature information, the candidate web page category corresponding to the feature information with the highest confidence is determined as the target web page category to which the web page to be classified belongs. Since the selected feature information has a high confidence, the accuracy of web page classification may be further improved.

Alternatively, in case that the largest confidence among all the normalized confidences is less than the first preset threshold, a preset category is determined as the target web page category to which the web page to be classified belongs, wherein the preset category comprises a low-quality web page category.

In this way, considering that the quality of the web page to be classified is not very high in the case that the confidence of each kind of feature information is low, the web page to be classified may be determined as a low-quality web page category. In other application areas of web page classification, e.g., in the area of web page recommendation, it is possible to avoid recommending low-quality web pages to users, and thus the quality of web page recommendation may be guaranteed.

The process of calculating the confidence of each feature information will be further explained below.

Alternatively, the confidence of the search engine optimization information is determined by: according to the search engine optimization information, determining a first rank value of the web page to be classified in a first search engine; if the first rank value is within a preset number of top rank, determining the confidence of the search engine optimization information as a preset confidence; if the first rank value is out of the preset number of top rank, determining an auxiliary web page of the web page to be classified, and determining a second rank value of the web page to be classified and the auxiliary page in a second search engine; according to the second rank value of the web page to be classified and the auxiliary web page in the second search engine, determining an average rank value of the web page to be classified and the auxiliary web page; calculating the confidence of the search engine optimization information by following equation: Con1=sigmoid((M+T)/R+(K−R)/M); where Con1 is the confidence of the search engine optimization information, M is a lowest rank value of the web page to be classified and the auxiliary web page in the second search engine, T is the preset number, K is the average rank value, and R is the first rank value of the web page to be classified.

It is noteworthy that according to the search engine optimization information of a web page, the topper the rank in the search engine, the higher the confidence. When the rank is less than a certain threshold (i.e., the rank is top 10), the search engine optimization information is considered to be credible, and then the confidence of the search engine optimization information may be determined as a preset confidence. In the present disclosure, the preset confidence may be set according to actual situation.

In another possible way, according to the specific rank of the first rank value within the preset number of top rank, a corresponding preset confidence may be further set, e.g., setting an association table of a plurality of rank values and a preset confidence corresponding to each rank value, and if the first rank value is within the preset number of top rank, determining the confidence of the search engine optimization information as the preset confidence by querying the association table.

As an example, the preset number may be 5 or 10, and the present embodiment does not limit in this regard.

In the present disclosure, the auxiliary web page is a web page that belongs to the same category as the web page category corresponding to the search engine optimization information, and the auxiliary web page is used to assist in calculating the confidence of the search engine optimization information.

It is noteworthy that the first search engine and the second search engine are different search engines.

Alternatively, the confidence of the web page sharing information is determined by: obtaining a first user number shared from a third-party web site to the web page to be classified and a second user number accessing the web page to be classified; and determining the confidence of the web page sharing information according to the first user number and the second user number.

It is noteworthy that the first user number characterizes a user number sharing the web page to be classified (shared to a third-party website), and the second user number characterizes a user number accessing the web page to be classified, wherein the first user number and the second user number may be obtained through web crawling techniques.

As an example, a ratio of the first user number to the second user number may be determined as the confidence that the web page sharing information, and it may be understood that the ratio of the first user number to the second user number may be characterized as a sharing rate of users.

In this way, data (the sharing rate) characterizing user behavior is used to feed web page classification results back. Since the user behavior data may reflect the authenticity of data to a certain extent, when errors occur in web page classification results, the confidence of the feature information is further characterized by the data characterizing user behavior, which can provide the system with the ability to self-correct classification errors to improve the accuracy of web page classification.

Alternatively, the confidence of the web page advertisement information is determined by: obtaining a click-through rate, a bounce rate and an exit rate of an advertisement corresponding to the web page advertisement information; calculating the confidence of the web page advertisement information by the following equation: Con2=CTR/(bounceᵣₐₜₑ+A*exiteᵣₐₜₑ), wherein Con2 is the confidence of the web page advertisement information, CTR is the click-through rate, bounceᵣₐₜₑ is the bounce rate, exiteᵣₐₜₑ is the exit rate, and A is a preset website parameter.

It is noteworthy that the click-through rate of the advertisement characterizes the click-to-reach rate of the advertisement, i.e., the ratio of actual clicks on an advertisement to the number of advertisements displayed.

The bounce rate of the advertisement characterizes the percentage of visits that leave after visiting the page entry to the total number of visits, which is equivalent to the percentage of visits that leave a website (the website comprises a plurality of web pages) after visiting a page to the total number of visits to the web site. It may be understood that the web page to be classified is a web page under the website.

The exit rate of the advertisement characterizes the percentage of page visits that users exit from the page to be classified to page visits that users enter the page to be classified, wherein page visits exiting from the page to be classified comprise the number of occurrences that a user bounces from a single page (page to be classified) during a visit, as well as the number of occurrences that a user bounces from the page to be classified after browsing multiple pages. Page visits entering the web page to be classified comprise the number of occurrences that a user repetitively browses the web page to be classified.

As an example, after 10 visits come to page a, 5 visits directly leave from page a, 3 visits come to page b, and 2 visits come to page c and then directly leave, wherein 2 of 3 visits to page b return to page a and finally leave from page a. Thus, the bounce rate of page a is calculated as (5/10)*100%, and the exit rate of page a is calculated as ((5+2)/(10+2))*100%.

The preset website parameter is related to the scale and size of the website and may be set by manual specification or supervised learning methods, which is not limited in the present embodiment.

Alternatively, the confidence of the web page rendering information is determined by: extracting a preset number of rendering local information at different positions in the rendering image result; based on various rendering local information, determining whether the various rendering local information is related to the candidate web page category corresponding to the web page rendering information; and determining the confidence of the web page rendering information according to the number of rendering local information associated with the candidate web page category corresponding to the web page rendering information and a preset number.

As an example, the different positions may be different textual positions and different picture positions in the rendering image result.

In the present disclosure, determining whether the each rendering local information is related to the candidate web page category of the web page rendering information may be: determining whether keyword information of the each rendering local information corresponds to keyword information of the candidate web page category corresponding to the web page rendering information or not; if yes, then determining the rendering local information is related to the candidate web page category corresponding to the web page rendering information; if not, then determining the rendering local information is not related to the candidate web page category corresponding to the web page rendering information. The step of determining whether the each rendering local information is related to the candidate web page category corresponding to the web page rendering information will be further explained by taking sports as an example of the web page category.

As an example, where the extracted rendering local information is sports shoes and the candidate web page category corresponding to the web page rendering information is sports, apparently keywords for sports may be sports shoes, sportswear, sports equipment, etc. Therefore, the rendering local information corresponds to the keyword of the candidate web page category corresponding to the web page rendering information, which also indicates that the rendering local information is related to the candidate web page category corresponding to the web page rendering information.

It may be understood that the larger the proportion of the number of extracted rendering local information extracted that is related to the candidate web page category corresponding to the web page rendering information to the number of all extracted rendering local information, the higher the confidence of the web page rendering information. Therefore, the ratio of the number of rendering local information that is related to the candidate web page category corresponding to the web page rendering information to a preset number is determined as the confidence of the web page rendering information.

In a possible implementation, the step of determining the confidence of the various feature information may comprise: with respect to each two candidate web page categories among all the candidate web page categories, determining the similarity between the two candidate web page categories; determining the confidence of the each feature information where at least one similarity among all the similarities is less than a second preset threshold.

As an example, the similarity between each two candidate web page categories may be calculated using similarity calculation methods in the related art, which is not detailed in the present embodiment.

It is noteworthy that the second preset threshold may be set according to actual situation, and the present embodiment is not intended to limit this regard.

Considering that all predicted similarities between candidate web page categories of the feature information of the web page category of the web page to be classified are determined to be large, there is no need to calculate the confidence to determine the feature information with the highest confidence and determine the web page candidate category corresponding to the feature information as the target web page category. In this way, where at least one similarity among all the similarities is less than the second preset threshold, the step of determining the confidence of the each feature information is then performed, which reduces the number of computation and improves the classification efficiency of the web page classification.

In a possible implementation, where all the similarities are greater than or equal to the second preset threshold, any one of all the candidate web page categories is determined as the target web page category to which the web page to be classified belongs.

Considering that all predicted similarities between candidate web page categories of the feature information of the web page category of the web page to be classified are determined to be large, all the candidate web page categories may be used as the target web page category to which the web page to be classified belongs. Therefore, in this case, any one of all the candidate web page categories is directly determined as the target web page category to which the web page to be classified belongs, to improve the classification accuracy of web page classification.

The embodiments of the present disclosure further provide a web page classification apparatus, which can become a part or all of an electronic device through software, hardware or a combination thereof. FIG. 2 is a block diagram of a web page classification apparatus according to an example embodiment of the present disclosure. With reference to FIG. 2, the web page classification apparatus 200 comprises:
a first obtaining module 201 for obtaining feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified;
a predicting module 202 for respectively predicting a candidate web page category of the web page to be classified according to each feature information;
a determining module 203 for determining a target web page category to which the web page to be classified belongs from all the candidate web page categories of the web page to be classified.

Alternatively, the determining module 203 comprises:
a confidence determining sub-module for determining a confidence of the each feature information;
a normalizing sub-module for normalizing all the confidences;
a first determining sub-module for determining a candidate web page category corresponding to the feature information corresponding to the largest confidence as the target web page category to which the web page to be classified belongs in case that the largest confidence among all the normalized confidences is greater than or equal to a first preset threshold.

Alternatively, the determining module 203 further comprises:
a second determining sub-module for, determining a preset category as the target web page category to which the web page to be classified belongs in case that the largest confidence among all the normalized confidences is less than the first preset threshold, wherein the preset category comprises a low-quality web page category.

Alternatively, the apparatus 200 further comprises:
a first rank determining module for determining a first rank value of the web page to be classified in a first search engine according to the search engine optimization information;
a preset determining module for, if the first rank value is within a preset number of top rank, determining the confidence of the search engine optimization information as a preset confidence;
a web page determining module for, determining an auxiliary web page of the web page to be classified in case that the first rank value is out of the preset number of top rank, wherein the auxiliary web page is a web page that belongs to the same category as the web page category corresponding to the search engine optimization information;
a second rank determining module for determining a second rank value of the web page to be classified and the auxiliary page in a second search engine;
an average ranking determining module for determining an average rank value of the web page to be classified and the auxiliary web page according to the second rank value of the web page to be classified and the auxiliary web page in the second search engine;
a first calculating module for calculating the confidence of the search engine optimization information by the following equation:

$$Con 1 = sigmoid ( ( M + T ) / R + ( K - R ) / M ) ;$$

where Con1 is the confidence of the search engine optimization information, M is a lowest rank value of the web page to be classified and the auxiliary web page in the second search engine, T is the preset number, K is the average rank value, and R is the first rank value of the web page to be classified.

Alternatively, the apparatus 200 further comprises:
a second obtaining module for obtaining a first user number shared from the third-party website to the web page to be classified and a second user number accessing the web page to be classified;
a second calculating module for determining the confidence of the web page sharing information according to the first user number and the second user number.

Alternatively, the apparatus 200 further comprises:
a third obtaining module for obtaining a click-through rate, a bounce rate and an exit rate of an advertisement corresponding to the web page advertisement information;
a third calculating module for calculating the confidence of the web page advertisement information by the following equation:

$$C o n 2 = CTR / ( {bounce}_{r a t e} + A * {exite}_{r a t e} ) ;$$

where Con2 is the confidence of the web page advertisement information, CTR is the click-through rate, bounceᵣₐₜₑ is the bounce rate, exiteᵣₐₜₑ is the exit rate, and A is a preset website parameter.

Alternatively, the apparatus 200 further comprises:
an extracting module for extracting a preset number of rendering local information at different positions in the rendering image result;
a judging module for, according to each rendering local information, determining whether the each rendering local information is related to the candidate web page category corresponding to the web page rendering information;
a fourth calculating module for determining the confidence of the web page rendering information according to the number of rendering local information related to the candidate web page category corresponding to the web page rendering information and the preset number.

Alternatively, the confidence determining sub-module is specifically used for, for each two candidate web page categories among all the candidate web page categories, determining a similarity between the two candidate web page categories; determining the confidence of the each feature information where at least one similarity among all the similarities is less than a second preset threshold.

Alternatively, the confidence determining sub-module is further used for, in case that all the similarities are greater than or equal to the second preset threshold, determining any one of all the candidate web page categories as the target web page category to which the web page to be classified belongs.

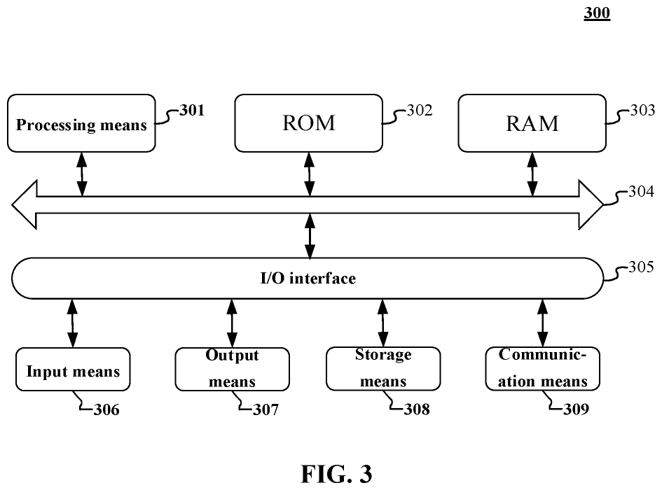

Reference is made to FIG. 3 below, which shows a structural schematic diagram of an electronic device (e.g., the terminal device or server in FIG. 1) 300 suitable for implementing the embodiments of the present disclosure. The terminal device in the embodiments of the present disclosure may include, without limitation to, a mobile terminal such as a mobile phone, a laptop computer, a digital broadcast receiver, a PDA (personal digital assistant), a PAD (tablet computer), a PMP (portable multimedia player), an on-board terminal (e.g., on-board navigation terminal) and the like, as well as a fixed terminal such as a digital TV, a desktop computer and the like. The electronic device shown in FIG. 3 is merely an example and should not be construed to impose any limitations on the functionality and use scope of the embodiments of the present disclosure.

As shown in FIG. 3, the electronic device 300 may comprises processing means (e.g., a central processor, a graphics processor) 301 which is capable of performing various appropriate actions and processes in accordance with programs stored in a read only memory (ROM) 302 or programs loaded from storage means 308 to a random access memory (RAM) 303. In the RAM 303, there are also stored various programs and data required by the electronic device 300 when operating. The processing means 301, the ROM 302 and the RAM 303 are connected to one another via a bus 304. An input/output (I/O) interface 305 is also connected to the bus 304.

Usually, the following means may be connected to the I/O interface 305: input means 306 including a touch screen, a touch pad, a keyboard, a mouse, a camera, a microphone, an accelerometers, a gyroscope, or the like; output means 307, such as a liquid-crystal display (LCD), a loudspeaker, a vibrator, or the like; storage means 308, such as a magnetic tape, a hard disk or the like; and communication means 309. The communication means 309 allows the electronic device 300 to perform wireless or wired communication with other device to exchange data with other device. While FIG. 3 shows the electronic device 300 with various means, it should be understood that it is not required to implement or have all of the illustrated means. Alternatively, more or less means may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication means 309, or installed from the storage means 308, or installed from the ROM 302. The computer program, when executed by the processing means 301, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium including or storing a program that may be used by or in conjunction with an instruction executing system, apparatus or device. In the present disclosure, the computer readable signal medium may include data signals propagated in the baseband or as part of the carrier waveform, in which computer readable program code is carried. Such propagated data signals may take a variety of forms, including without limitation to electromagnetic signals, optical signals, or any suitable combination of the foregoing. The computer readable signal medium may also be any computer readable medium other than a computer readable storage medium that may send, propagate, or transmit a program for use by, or in conjunction with, an instruction executing system, apparatus, or device. The program code contained on the computer readable medium may be transmitted by any suitable medium, including, but not limited to, a wire, a fiber optic cable, RF (radio frequency), etc., or any suitable combination thereof.

In some implementations, the client and server may communicate utilizing any currently known or future developed network protocol such as HTTP (HyperText Transfer Protocol) and may be interconnected with digital data communications (e.g., communication networks) of any form or medium. Examples of communication networks include local area networks (“LANs”), wide area networks (“WANs”), inter-networks (e.g., the Internet), and end-to-end networks (e.g., ad hoc end-to-end networks), as well as any currently known or future developed networks.

The above computer readable medium may be contained in the above electronic device; or it may exist separately and not be assembled into the electronic device.

The above computer readable medium carries one or more programs which, when executed by the electronic device, cause the electronic device to: obtain feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified; respectively predict a candidate web page category of the web page to be classified according to each feature information; determine a target web page category to which the web page to be classified belongs from all the candidate web page categories of the web page to be classified.

Computer program code for carrying out operations of the present disclosure may be written in one or more program designing languages or a combination thereof, which include without limitation to an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Modules involved in the embodiments of the present disclosure as described may be implemented in software or hardware. The name of a module does not form any limitation on the module itself. For example, the first obtaining module may further be described as a “module for obtaining at least two Internet Protocol addresses.”

The functionality described above may at least partly be performed, at least in part, by one or more hardware logic components. For example and in a non-limiting sense, exemplary types of hardware logic components that can be used include: field-programmable gate arrays (FPGA), application specific integrated circuits (ASICs), application specific standard products (ASSPs), systems on chips (SOCs), complex programmable logic devices (CPLDs), etc.

In the context of the present disclosure, the machine readable medium may be a tangible medium that can retain and store programs for use by or in conjunction with an instruction execution system, apparatus or device. The machine readable medium of the present disclosure can be a machine readable signal medium or a machine readable storage medium. The machine readable medium may include, but is not limited to, an electronic, magnetic, optical, electromagnetic, infrared or semiconductor system, apparatus or device, or any combination of the foregoing. More specific examples of the machine readable storage medium may include, without limitation to, the following: an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments, Example 1 provides a web page classification method, comprising: obtaining feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified; respectively predicting a candidate web page category of the web page to be classified according to each feature information; determining a target web page category to which the web page to be classified belongs from all the candidate web page categories of the web page to be classified.

According to one or more embodiments of the present disclosure, Example 2 provides a method of Example 1, the determining a target web page category to which the web page to be classified belongs from all the candidate web page categories of the web page to be classified comprising:

determining a confidence of the each feature information; normalizing all the confidences; in case that the largest confidence among all the normalized confidences is greater than or equal to a first preset threshold, determining a candidate web page category corresponding to the feature information corresponding to the largest confidence as the target web page category to which the web page to be classified belongs.

According to one or more embodiments of the present disclosure, Example 3 provides a method of Example 2, the method further comprising: in case that the largest confidence among all the normalized confidences is less than the first preset threshold, determining a preset category as the target web page category to which the web page to be classified belongs, wherein the preset category comprises a low-quality web page category.

According to one or more embodiments of the present disclosure, Example 4 provides a method of Example 3, the feature information comprising the search engine optimization information, the confidence of the search engine optimization information being determined by: determining a first rank value of the web page to be classified in a first search engine according to the search engine optimization information; in case that the first rank value is within a preset number of top rank, determining the confidence of the search engine optimization information as a preset confidence; in case that the first rank value is out of the preset number of top rank, determining an auxiliary web page of the web page to be classified, wherein the auxiliary web page is a web page that belongs to the same category as the web page category corresponding to the search engine optimization information; determining a second rank value of the web page to be classified and the auxiliary page in a second search engine; determining an average rank value of the web page to be classified and the auxiliary web page according to the second rank value of the web page to be classified and the auxiliary web page in the second search engine; calculating the confidence of the search engine optimization information by the following equation:

Con1=sigmoid((M+T)/R+(K−R)/M); where Con1 is the confidence of the search engine optimization information, M is a lowest rank value of the web page to be classified and the auxiliary web page in the second search engine, T is the preset number, K is the average rank value, and R is the first rank value of the web page to be classified.

According to one or more embodiments of the present disclosure, Example 5 provides a method of Example 2, the feature information comprising the web page sharing information, the confidence of the web page sharing information being determined by: obtaining a first user number shared from the third-party website to the web page to be classified and a second user number accessing the web page to be classified; determining the confidence of the web page sharing information according to the first user number and the second user number.

According to one or more embodiments of the present disclosure, Example 6 provides a method of Example 2, the feature information comprising the web page advertisement information, the confidence of the web page advertisement information being determined by: obtaining a click-through rate, a bounce rate and an exit rate of an advertisement corresponding to the web page advertisement information; calculating the confidence of the web page advertisement information by the following equation: Con2=CTR/(bounce rate+A*exiteᵣₐₜₑ); wherein Con2 is the confidence of the web page advertisement information, CTR is the click-through rate, bounceᵣₐₜₑ is the bounce rate, exiteᵣₐₜₑ is the exit rate, and A is a preset website parameter.

According to one or more embodiments of the present disclosure, Examples 7 provides a method of Example 2, the feature information comprising the web page rendering information, the confidence of the web page rendering information being determined by: extracting a preset number of rendering local information at different positions in the rendering image result; based on each rendering local information, determining whether the each rendering local information is related to the candidate web page category corresponding to the web page rendering information; determining the confidence of the web page rendering information according to the number of rendering local information related to the candidate web page category corresponding to the web page rendering information and the preset number.

According to one or more embodiments of the present disclosure, Example 8 provides a method of Examples 2-7, the determining the confidence of the each feature information comprising: with respect to each two candidate web page categories among all the candidate web page categories, determining the similarity between the two candidate web page categories; determining the confidence of the each feature information where at least one similarity among all the similarities is less than a second preset threshold.

According to one or more embodiments of the present disclosure, Example 9 provides a method of Example 8, the method further comprising: in case that all the similarities are greater than or equal to the second preset threshold, determining any one of all the candidate web page categories as the target web page category to which the web page to be classified belongs.

According to one or more embodiments, Example 10 provides a web page classification apparatus, comprising: a first obtaining module for obtaining feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified; a predicting module for respectively predicting a candidate web page category of the web page to be classified according to each feature information; a determining module for determining a target web page category to which the web page to be classified belongs from all the candidate web page categories of the web page to be classified.

According to one or more embodiments of the present disclosure, Example 11 provides an apparatus of Example 10, the determining module comprising: a confidence determining sub-module for determining a confidence of the each feature information; a normalizing sub-module for normalizing all the confidences; a first determining sub-module for, in case that the largest confidence among all the normalized confidences is greater than or equal to a first preset threshold, determining a candidate web page category corresponding to the feature information corresponding to the largest confidence as the target web page category to which the web page to be classified belongs.

According to one or more embodiments of the present disclosure, Example 12 provides an apparatus of Example 11, the determining module further comprising: a second determining sub-module for, in case that the largest confidence among all the normalized confidences is less than the first preset threshold, determining a preset category as the target web page category to which the web page to be classified belongs, wherein the preset category comprises a low-quality web page category.

According to one or more embodiments of the present disclosure, Example 13 provides an apparatus of Example 11, the apparatus further comprising: a first rank determining module for determining a first rank value of the web page to be classified in a first search engine according to the search engine optimization information; a preset determining module for, in case that the first rank value is within a preset number of top rank, determining the confidence of the search engine optimization information as a preset confidence; a web page determining module for, in case that the first rank value is out of the preset number of top rank, determining an auxiliary web page of the web page to be classified, wherein the auxiliary web page is a web page that belongs to the same category as the web page category corresponding to the search engine optimization information; a second rank determining module for determining a second rank value of the web page to be classified and the auxiliary page in a second search engine; an average ranking module for determining an average rank value of the web page to be classified and the auxiliary web page according to the second rank value of the web page to be classified and the auxiliary web page in the second search engine; a first calculating module for calculating the confidence of the search engine optimization information by the following equation: Con1=sigmoid((M+T)/R+(K−R)/M); where Con1 is the confidence of the search engine optimization information, M is a lowest rank value of the web page to be classified and the auxiliary web page in the second search engine, T is the preset number, K is the average rank value, and R is the first rank value of the web page to be classified.

According to one or more embodiments of the present disclosure, Example 14 provides an apparatus of Example 11, the apparatus further comprising: a second obtaining module for obtaining a first user number shared from the third-party website to the web page to be classified and a second user number accessing the web page to be classified; a second calculating module for determining the confidence of the web page sharing information according to the first user number and the second user number.

According to one or more embodiments of the present disclosure, Example 15 provides an apparatus of Example 11, the apparatus further comprising: a third obtaining module for obtaining a click-through rate, a bounce rate and an exit rate of an advertisement corresponding to the web page advertisement information; a third calculating module for calculating the confidence of the web page advertisement information by the following equation: Con2=CTR/(bounceᵣₐₜₑ+A*exiteᵣₐₜₑ); wherein Con2 is the confidence of the web page advertisement information, CTR is the click-through rate, bounceᵣₐₜₑ is the bounce rate, exiteᵣₐₜₑ is the exit rate, and A is a preset website parameter.

According to one or more embodiments of the present disclosure, Example 16 provides an apparatus of Example 11, the apparatus further comprising: an extracting module for extracting a preset number of rendering local information at different positions in the rendering image result; a judging module for, based on each rendering local information, determining whether the each rendering local information is related to the candidate web page category corresponding to the web page rendering information; a fourth determining module for determining the confidence of the web page rendering information according to the number of rendering local information related to the candidate web page category corresponding to the web page rendering information and the preset number.

According to one or more embodiments of the present disclosure, Example 17 provides an apparatus of Examples 11-16, the confidence determining sub-module is specifically used for, for each two candidate web page categories among all the candidate web page categories, determining a similarity between the two candidate web page categories; determining the confidence of the each feature information in case that at least one similarity among all the similarities is less than a second preset threshold.

According to one or more embodiments of the present disclosure, Example 18 provides an apparatus of Example 17, the confidence determining sub-module is further used for, in case that all the similarities are greater than or equal to the second preset threshold, determining any one of all the candidate web page categories as the target web page category to which the web page to be classified belongs.

According to one or more embodiments of the present disclosure, Example 19 provides a computer readable medium with a computer program stored thereon, the program, when executed by processing means, performing steps of the method according to any of Examples 1-9.

According to one or more embodiments of the present disclosure, Example 20 provides an electronic device, comprising:
storage mean, on which a computer program is stored;
processing means, for executing the computer program in the storage means to perform steps of the method according to any of Examples 1-9.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion includes several specific implementation details, they should not be construed as limiting the scope of the present disclosure. Some features described in the context of separate embodiments may also be realized in combination in a single embodiment. On the contrary, various features described in the context of a single embodiment may also be realized in multiple embodiments, either individually or in any suitable sub-combinations.

While the present subject matter has been described using language specific to structural features and/or method logic actions, it should be understood that the subject matter defined in the appended claims is not necessarily limited to the particular features or actions described above. On the contrary, the particular features and actions described above are merely exemplary forms of realizing the claims. With respect to the apparatus in the above embodiment, the specific manner in which each module performs an operation has been described in detail in the embodiments relating to the method, and will not be detailed herein.

1. A web page classification method, wherein the method comprises:
obtaining feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified;
respectively predicting a candidate web page category of the web page to be classified according to each feature information;
determining a target web page category to which the web page to be classified belongs from all the candidate web page categories of the web page to be classified.

2. The method according to claim 1, wherein determining a target web page category to which the web page to be classified belongs from all the candidate web page categories of the web page to be classified comprises:
determining a confidence of the each feature information;
normalizing all the confidences;
determining a candidate web page category corresponding to the feature information corresponding to the largest confidence as the target web page category to which the web page to be classified belongs in case that a largest confidence among all the normalized confidences is greater than or equal to a first preset threshold.

3. The method according to claim 2, wherein the method further comprises:
determining a preset category as the target web page category to which the web page to be classified belongs, in case that the largest confidence among all the normalized confidences is less than the first preset threshold, wherein the preset category comprises a low-quality web page category.

4. The method according to claim 2, wherein the feature information comprises the search engine optimization information, the confidence of the search engine optimization information being determined by:
determining a first rank value of the web page to be classified in a first search engine according to the search engine optimization information;
determining the confidence of the search engine optimization information as a preset confidence when the first rank value is within a preset number of top rank;
determining an auxiliary web page of the web page to be classified when the first rank value is out of the preset number of top rank, wherein the auxiliary web page is a web page that belongs to the same category as the web page category corresponding to the search engine optimization information;
determining a second rank value of the web page to be classified and the auxiliary page in a second search engine;
determining an average rank value of the web page to be classified and the auxiliary web page according to the second rank value of the web page to be classified and the auxiliary web page in the second search engine;
calculating a confidence of the search engine optimization information by following equation:
$$Con 1 = sigmoid ( ( M + T ) / R + ( K - R ) / M ) ;$$
where Con1 is the confidence of the search engine optimization information, M is a lowest rank value of the web page to be classified and the auxiliary web page in the second search engine, T is the preset number, K is the average rank value, and R is the first rank value of the web page to be classified.

5. The method according to claim 2, wherein the feature information comprises the web page sharing information, the confidence of the web page sharing information being determined by:
obtaining a first user number shared from the third-party website to the web page to be classified and a second user number accessing the web page to be classified;
determining the confidence of the web page sharing information according to the first user number and the second user number

6. The method according to claim 2, wherein the feature information comprises the web page advertisement information, the confidence of the web page advertisement information being determined by:
obtaining a click-through rate, a bounce rate and an exit rate of an advertisement corresponding to the web page advertisement information;
calculating the confidence of the web page advertisement information by following equation:
$$C o n 2 = CTR / ( {bounce}_{r a t e} + A * {exite}_{r a t e} ) ;$$
where Con2 is the confidence of the web page advertisement information, CTR is the click-through rate, bounceᵣₐₜₑ is the bounce rate, exiteᵣₐₜₑ is the exit rate, and A is a preset website parameter.

7. The method according to claim 2, wherein the feature information comprises the web page rendering information, the confidence of the web page rendering information being determined by:
extracting a preset number of rendering local information at different positions in the rendering image result;
determining whether each rendering local information is related to the candidate web page category corresponding to the web page rendering information according to each rendering local information;
determining the confidence of the web page rendering information according to the number of rendering local information related to the candidate web page category corresponding to the web page rendering information and the preset number.

8. The method according to claim 2, wherein determining the confidences of the each feature information comprises:
for each two candidate web page categories among all the candidate web page categories, determining a similarity between the two candidate web page categories;
determining the confidence of the each feature information in case that at least one similarity among all the similarities is less than a second preset threshold.

9. The method according to claim 8, wherein the method further comprises:
determining any one of all the candidate web page categories as the target web page category to which the web page to be classified belongs in case that all the similarities are greater than or equal to the second preset threshold.

10. (canceled)

11. A non-transitory computer readable medium, on which a computer program is stored, wherein the computer program, when executed by processing means, performs steps of:
obtaining feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified;
respectively predicting a candidate web page category of the web page to be classified according to each feature information;
determining a target web page category to which the web page to be classified belongs from all the candidate web page categories of the web page to be classified.

12. An electronic device comprising:
storage means, on which a computer program is stored;
processing means for executing the computer program in the storage means to perform steps of:
obtaining feature information of a web page to be classified, the feature information comprising at least two of search engine optimization information, web page sharing information shared from the web page to be classified to a third-party website, web page advertisement information related to the web page to be classified and released on a platform by a website corresponding to the web page to be classified, and web page rendering information extracted from a rendering image result of the rendering of the web page to be classified;
respectively predicting a candidate web page category of the web page to be classified according to each feature information;
determining a target web page category to which the web page to be classified belongs from all the candidate web page categories of the web page to be classified.

13. The device according to claim 12, wherein determining a target web page category to which the web page to be classified belongs from all the candidate web page categories of the web page to be classified comprises:
determining a confidence of the each feature information;
normalizing all the confidences;
determining a candidate web page category corresponding to the feature information corresponding to the largest confidence as the target web page category to which the web page to be classified belongs in case that a largest confidence among all the normalized confidences is greater than or equal to a first preset threshold.

14. The device according to claim 13, wherein the steps further comprises:
determining a preset category as the target web page category to which the web page to be classified belongs, in case that the largest confidence among all the normalized confidences is less than the first preset threshold, wherein the preset category comprises a low-quality web page category.

15. The device according to claim 13, wherein the feature information comprises the search engine optimization information, the confidence of the search engine optimization information being determined by:
determining a first rank value of the web page to be classified in a first search engine according to the search engine optimization information;
determining the confidence of the search engine optimization information as a preset confidence when the first rank value is within a preset number of top rank;
determining an auxiliary web page of the web page to be classified when the first rank value is out of the preset number of top rank, wherein the auxiliary web page is a web page that belongs to the same category as the web page category corresponding to the search engine optimization information;
determining a second rank value of the web page to be classified and the auxiliary page in a second search engine;
determining an average rank value of the web page to be classified and the auxiliary web page according to the second rank value of the web page to be classified and the auxiliary web page in the second search engine;
calculating a confidence of the search engine optimization information by following equation:
$$Con 1 = sigmoid ( ( M + T ) / R + ( K - R ) / M ) ;$$
where Con1 is the confidence of the search engine optimization information, M is a lowest rank value of the web page to be classified and the auxiliary web page in the second search engine, T is the preset number, K is the average rank value, and R is the first rank value of the web page to be classified.

16. The device according to claim 13, wherein the feature information comprises the web page sharing information, the confidence of the web page sharing information being determined by:
obtaining a first user number shared from the third-party website to the web page to be classified and a second user number accessing the web page to be classified;
determining the confidence of the web page sharing information according to the first user number and the second user number

17. The device according to claim 13, wherein the feature information comprises the web page advertisement information, the confidence of the web page advertisement information being determined by:
obtaining a click-through rate, a bounce rate and an exit rate of an advertisement corresponding to the web page advertisement information;
calculating the confidence of the web page advertisement information by following equation:
$$C o n 2 = CTR / ( {bounce}_{r a t e} + A * {exite}_{r a t e} ) ;$$
where Con2 is the confidence of the web page advertisement information, CTR is the click-through rate, bounceᵣₐₜₑ is the bounce rate, exiteᵣₐₜₑ is the exit rate, and A is a preset website parameter.

18. The device according to claim 13, wherein the feature information comprises the web page rendering information, the confidence of the web page rendering information being determined by:
extracting a preset number of rendering local information at different positions in the rendering image result;
determining whether each rendering local information is related to the candidate web page category corresponding to the web page rendering information according to each rendering local information;
determining the confidence of the web page rendering information according to the number of rendering local information related to the candidate web page category corresponding to the web page rendering information and the preset number.

19. The device according to claim 13, wherein determining the confidences of the each feature information comprises:
for each two candidate web page categories among all the candidate web page categories, determining a similarity between the two candidate web page categories;
determining the confidence of the each feature information in case that at least one similarity among all the similarities is less than a second preset threshold.

20. The device according to claim 18, wherein the steps further comprises:
determining any one of all the candidate web page categories as the target web page category to which the web page to be classified belongs in case that all the similarities are greater than or equal to the second preset threshold.

21. The medium according to claim 11, wherein determining a target web page category to which the web page to be classified belongs from all the candidate web page categories of the web page to be classified comprises:
determining a confidence of the each feature information;
normalizing all the confidences;
determining a candidate web page category corresponding to the feature information corresponding to the largest confidence as the target web page category to which the web page to be classified belongs in case that a largest confidence among all the normalized confidences is greater than or equal to a first preset threshold.
